(19) United States
(12) Patent Application Publication
(10) Pub. No.: US 2024/0203276 A1
(43) Pub. Date: Jun. 20, 2024

(54) Presentation with Audience Feedback

(71) Applicant: DATHOMIR LABORATORIES LLC, Boston, MA (US)

(72) Inventors: Benjamin Hylak, San Francisco, CA (US); Aaron M. Burns, Sunnyvale, CA (US); Grant H. Mulliken, Los Gatos, CA (US); Mary A. Pyc, Campbell, CA (US); Nathan Gitter, Cupertino, CA (US); Pau Sastre Miguel, San Francisco, CA (US); Steven A. Marchette, Saratoga, CA (US)

(21) Appl. No.: 18/286,605

(22) PCT Filed: Apr. 6, 2022
(86) PCT No.: PCT/US22/23601

§ 371 Date: Oct. 12, 2023

Related U.S. Application Data
(60) Provisional application No. 63/174,276, filed on Apr. 13, 2021.

(51) Int. Cl. G09B 5/02; G06F 3/01

(52) U.S. Cl. CPC G09B 5/02; G06F 3/013

(57) ABSTRACT

In one implementation, a method of providing audience feedback during a performance of a presentation is performed at a device including a display, one or more processors, and non-transitory memory. The method includes displaying, on the display in association with an environment including a plurality of audience members, one or more slides of a presentation. The method includes, while displaying the one or more slides of the presentation, obtaining data regarding the plurality of audience members. The method includes displaying, on the display in association with the environment, one or more virtual objects based on the data regarding the plurality of audience members.

### CROSS-REFERENCE TO RELATED APPLICATIONS

This application claims priority to U.S. Provisional App. No. 63/174,276, filed on Apr. 13, 2021, which is hereby incorporated by reference in its entirety.

### TECHNICAL FIELD

The present disclosure generally relates to systems, methods, and devices for providing audience feedback during performance of a presentation.

### BACKGROUND

The primary purpose of many presentations is to convey information to an audience and/or persuade the audience to accept a particular interpretation of that information. However, many people find giving a presentation stressful, reducing the effectiveness of the presentation. Further, while giving the presentation, it can be difficult to gauge the effectiveness of the presentation.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4D illustrate an XR environment during a performance of a presentation in accordance with some implementations.

FIG. 5 is a flowchart representation of providing audience feedback during presentation of a presentation in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for providing audience feedback during a performance of a presentation. In various implementations, the method is performed by a device including a display, one or more processors, and non-transitory memory. The method includes displaying, on the display in association with an environment including a plurality of audience members, one or more slides of a presentation. The method includes, while displaying the one or more slides of the presentation, obtaining data regarding the plurality of audience members. The method includes displaying, on the display in association with the environment, one or more virtual objects based on the data regarding the plurality of audience members.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

The primary purpose of many presentations is to convey information to an audience and/or persuade the audience to accept a particular interpretation of that information. However, it is common for a person to feel anxiety or “stage fright” during performance of a presentation before other people, reducing the effectiveness of the presentation. Further, during performance of the presentation, it can be difficult for the performer to determine the effectiveness of the presentation and make changes to improve the effectiveness of the presentation. Accordingly, in various implementations, during a performance of a presentation, an electronic device obtains data regarding the audience and displays virtual objects based on the data regarding the audience. For example, in various implementations, the electronic device obtains eye tracking data indicative of where audience members are looking (either from an image of the audience or from electronic devices of the audience members that include an eye tracking camera) and displays an engagement bar indicative of a level of engagement of the audience with the presentation. As another example, in various implementations, the electronic device obtains motion data indicative of an audience member moving in the environment and displays a dimming window over the audience member to reduce the distraction to the presenter caused by the motion.

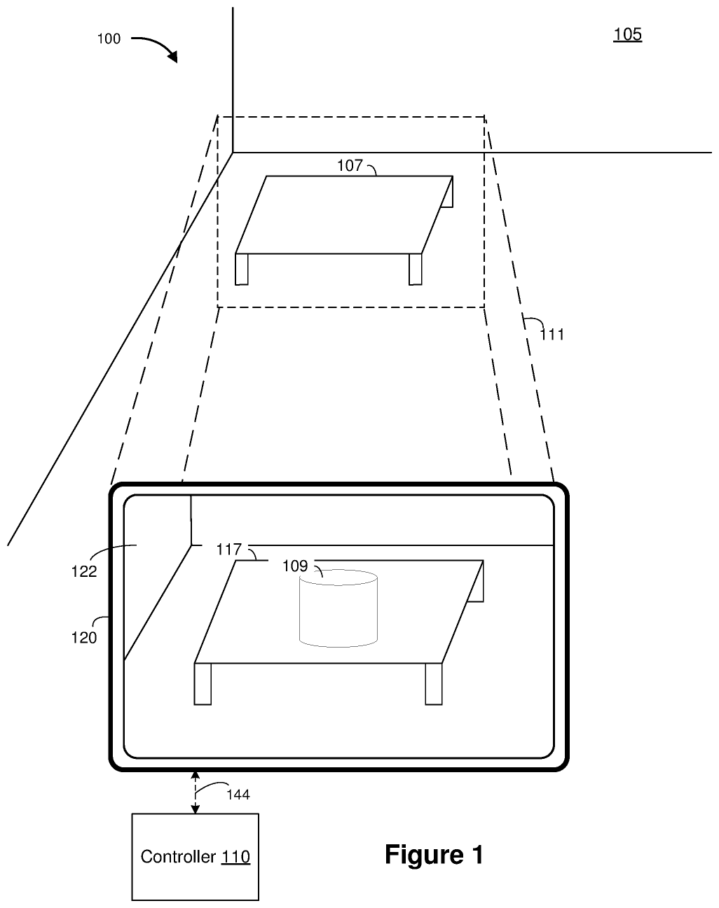

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

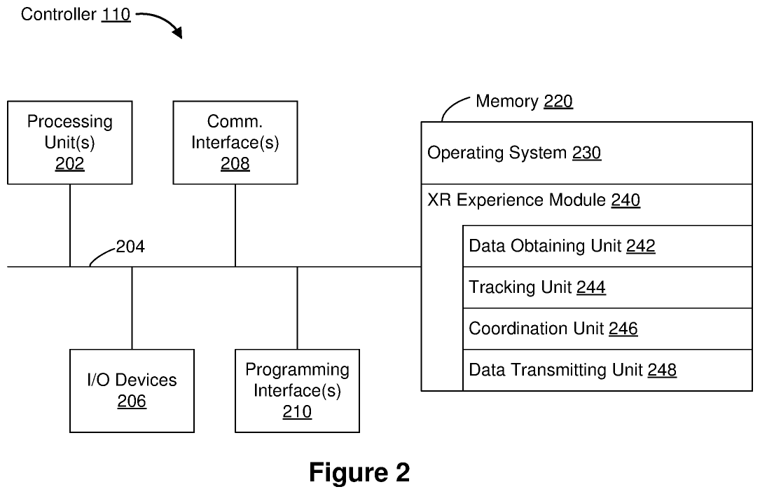

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

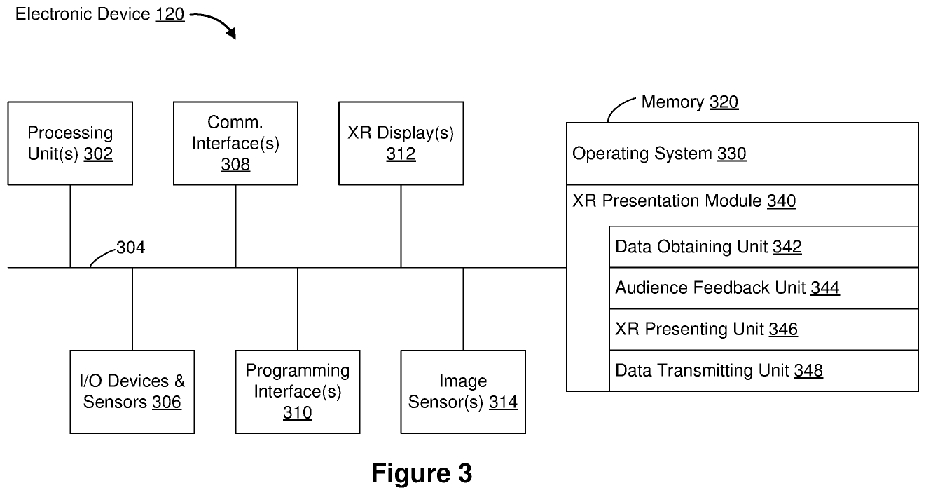

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (and may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, an audience feedback unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the audience feedback unit 344 is configured to obtain data regarding a plurality of audience members of a presentation and present XR content based on the data. To that end, in various implementations, the audience feedback unit 344 includes instructions and/or logic therefor, and heuristics and metadata therefor.

In some implementations, the XR presenting unit 346 is configured to present XR content via the one or more XR displays 312, such as a representation of the selected text input field at a location proximate to the text input device. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. In some implementations, the data transmitting unit 348 is configured to transmit authentication credentials to the electronic device. To that end, in various implementations, the data transmitting unit 348 includes instructions and/or logic therefor, and heuristics and metadata therefor.

Although the data obtaining unit 342, the audience feedback unit 344, the XR presenting unit 346, and the data transmitting unit 348 are shown as residing on a single device (e.g., the electronic device 120), it should be understood that in other implementations, any combination of the data obtaining unit 342, the audience feedback unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

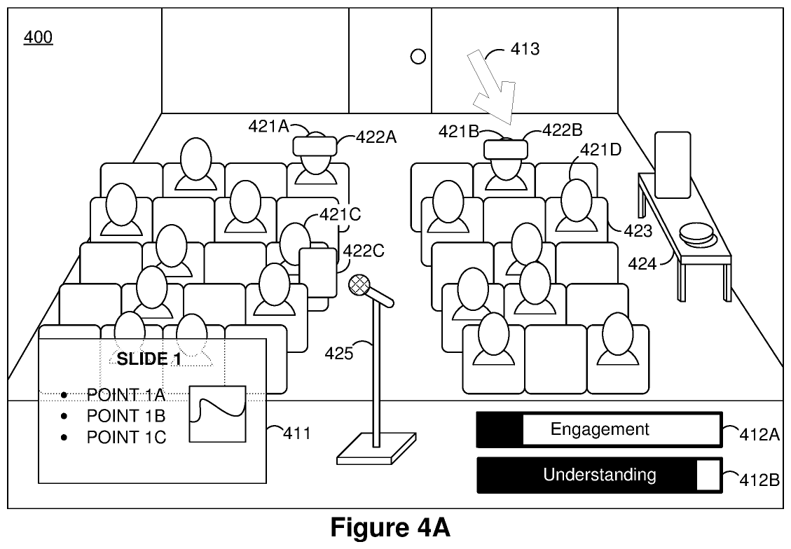

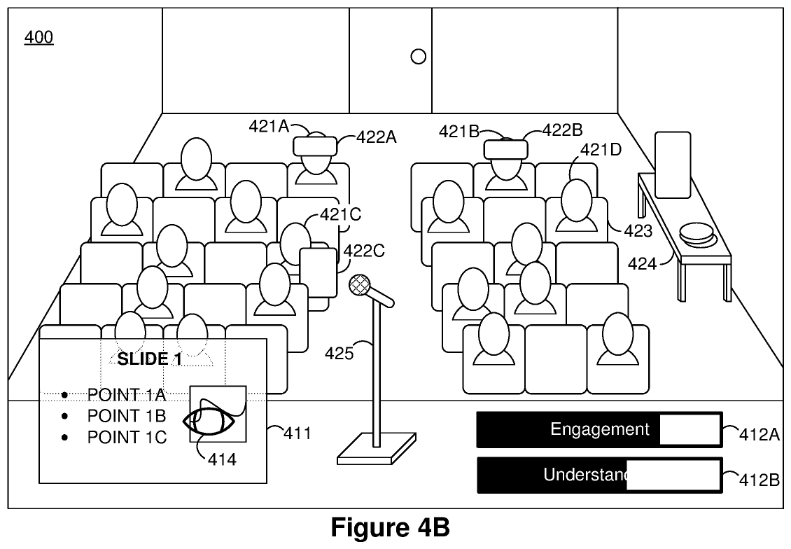

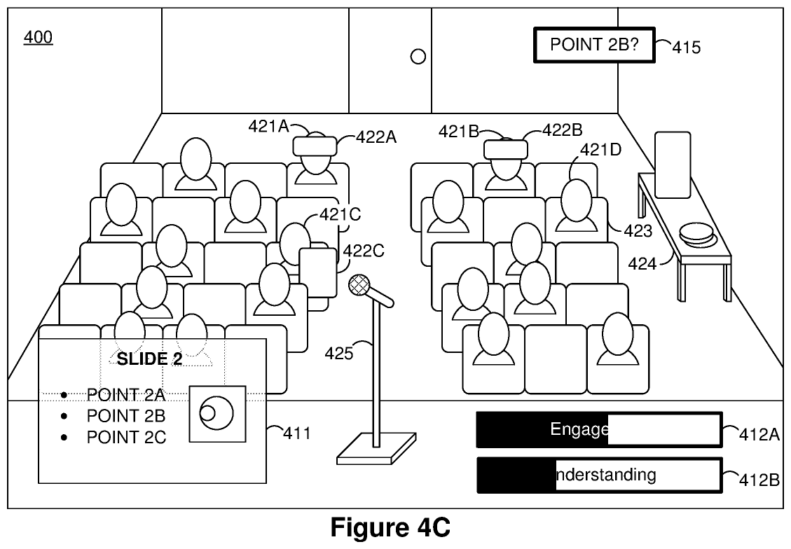

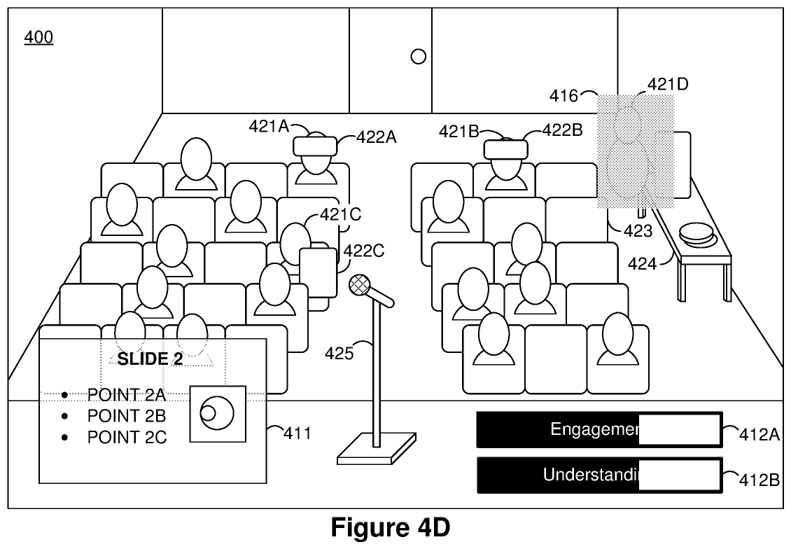

FIGS. 4A-4D illustrate an XR environment 400 displayed, at least in part, by a display of the electronic device. The XR environment 400 is based on a physical environment of an auditorium in which the electronic device and a plurality of physical audience members 421A-421D are present. In other implementations, the XR environment 400 can be a virtual environment in which virtual audience members (e.g., virtual representations or avatars of physically remote physical audience members) are present. FIGS. 4A-4D illustrate the XR environment 400 during a series of time periods. In various implementations, each time period is an instant, a fraction of a second, a few seconds, a few hours, a few days, or any length of time.

The XR environment 400 includes a plurality of objects, including one or more physical objects (e.g., the audience members 421A-421D, member electronic devices 422A-422C, a chair 423, a refreshment table 424, and a microphone 425) of the physical environment and one or more virtual objects (e.g., a slide window 411, an engagement bar 412A, an understanding bar 412B, and a member indicator 413). In various implementations, certain objects (such as the physical objects 421A-421D, 422A-422C, 423, 424, and 425 and the member indicator 413) are displayed at a location in the XR environment 400, e.g., at a location defined by three coordinates in a three-dimensional (3D) XR coordinate system. Accordingly, when the electronic device moves in the XR environment 400 (e.g., changes either position and/or orientation), the objects are moved on the display of the electronic device, but retain their location in the XR environment 400. Such virtual objects that, in response to motion of the electronic device, move on the display, but retain their position in the XR environment are referred to as world-locked objects. In various implementations, certain virtual objects (such as the slide window 411, the engagement bar 412A, and the understanding bar 412B) are displayed at locations on the display such that when the electronic device moves in the XR environment 400, the objects are stationary on the display on the electronic device. Such virtual objects that, in response to motion of the electronic device, retain their location on the display are referred to as head-locked objects or display-locked objects.

FIG. 4A illustrates the XR environment 400 during a first time period. During the first time period, the electronic device displays the slide window 411 displaying a first slide of a presentation. In various implementations, the slide window 411 is displayed at a fixed location on the display. In various implementations, the size and/or the location of the slide window 411 is manipulable by a user of the electronic device. For example, in various implementations, the user provides user input to move the slide window 411 to a different location on the display. As another example, in various implementations, the user provides user input to change a size of the slide window 411. In various implementations, the slide window 411 is at least partially transparent.

During the first time period, each of the plurality of audience members 421A-421D seated in a chair of the auditorium (e.g., a fourth audience member 421D is seated in the chair 423). Further, respective ones of the plurality of audience members 421A-421D have member electronic devices 422A-422C. For example, a first audience member 421A is wearing a first head-mounted device 422A, a second audience member 421B is wearing a second head-mounted device 422B, and a third audience member 421C is holding a smartphone 422C.

During the first time period, the electronic device (of the user) receives data regarding the plurality of audience members 421A-421D. In various implementations, the electronic device receives data from the member electronic devices 422A-422C. In various implementations, the electronic device captures, using an image sensor, an image of the plurality of audience members 421A-421D.

Based on the data regarding the plurality of audience members 421A-421D, the electronic device displays one or more virtual objects in the XR environment 400. For example, in FIGS. 4A-4D, the electronic device displays an engagement bar 412A that indicates a level of engagement of the plurality of audience members 421A-421D. For example, in FIGS. 4A-4D, the engagement bar is more full when the level of engagement is high and is less full when the level of engagement is low.

In various implementations, the electronic device determines the level of engagement based on the data regarding the plurality of audience members. For example, from an image of the plurality of audience members, the electronic device determines whether audience members are looking towards the user (and are, therefore, engaged) or away from the user (and are, therefore, not engaged). As another example, from an image of the plurality of audience members, the electronic device determines the facial expressions and/or body poses of audience members as either being consistent with being engaged with the presentation or not engaged with the presentation.

As another example, from eye tracking data (indicating where audience members are looking) received from the member electronic devices, the electronic device determines whether audience members are looking towards the user or away from the user. As another example, from text data received from the member electronic devices indicative of text input by the audience members on the member electronic devices, the device determines whether the text input is related to the content of the presentation as determined by the text of the slides or speech of the user (and are, therefore, engaged) or unrelated to the content of the presentation (and are, therefore, not engaged).

As another example, in FIGS. 4A-4D, the electronic device displays an understanding bar 412B that indicates a level of understanding of the plurality of audience members 421A-421D. For example, in FIGS. 4A-4D, the understanding bar is more full when the level of understanding is high and is less full when the level of understanding is low.

In various implementations, the electronic device determines the level of understanding based on the data regarding the plurality of audience members. For example, from an image of the plurality of audience members, the electronic device determines the facial expressions and/or body poses of audience members as either being consistent with understanding the presentation (e.g., nodding) or not understanding the presentation (e.g., furrowing the brow).

As another example, from text data received from the member electronic devices indicative of text input by the audience members on the member electronic devices, the device determines whether audience members are performing web searches to understand basic content of the presentation (and are, therefore, not understanding) or extended content related to the presentation (and are, therefore, understanding).

During the first time period, the electronic device displays a member indicator 413 in association with the second audience member 421B. In various implementations, the member indicator is a virtual world-locked object that indicates a particular audience member. In various implementations, the member indicator 413 is based on the data regarding the plurality of audience members. For example, in various implementations, the member indicator 413 is displayed in association with an audience member with a particularly low level of engagement with the presentation. As another example, in various implementations, the member indicator 413 is displayed in associated with an audience member raising his or her hand to ask a question (as determined by an image of the plurality of audience members).

FIG. 4B illustrates the XR environment 400 during a second time period subsequent to the first time period. During the second time period, the electronic device displays an eye tracking indicator 414 over the slide window 411. The eye tracking indicator 414 indicates a portion of the slide at which the plurality of audience members are gazing based on eye tracking data received by the members' electronic devices. In various implementations, the eye tracking indicator 414 is displayed as a heat map.

During the second time period, the user provides a next-slide user input. In various implementations, the next-slide input is a hand gesture or a vocal command.

FIG. 4C illustrates the XR environment 400 during a third time period subsequent to the second time period. During the third time period, in response to the next-slide user input, the slide window 411 displays a second slide of the presentation. Also during the third time period, the electronic device displays a text feedback notification 415 including text based on text data received from the member electronic devices indicative of text input by the audience members on the member electronic devices. For example, if a number of audience members are searching for a term (e.g., “POINT 2B?”), the text feedback notification 415 includes this text, prompting the user to provide additional information to the audience members and increase the audience members level of understanding.

FIG. 4D illustrates the XR environment 400 during a fourth time period subsequent to the third time period. During the fourth time period, the fourth audience member 421D has left the chair 423 and moved toward the refreshment table 424. Based on an image of the plurality of audience members, the electronic device displays a virtual dim window 416 surrounding the motion of the fourth audience member 421D to reduce user distraction caused by the movement and focus user attention on engaged audience members.

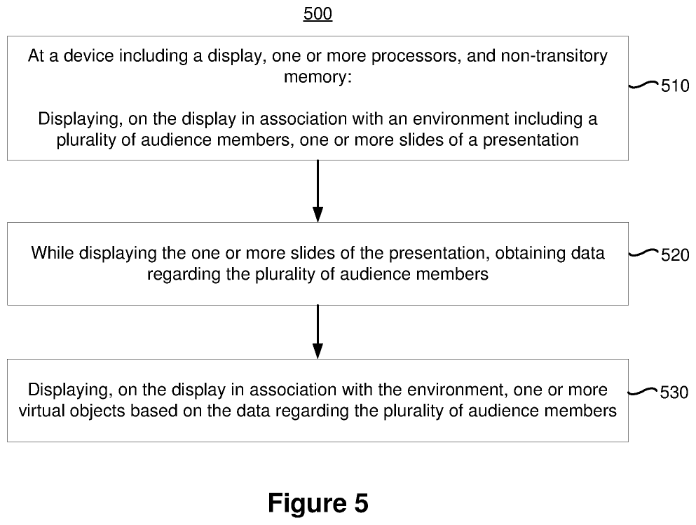

FIG. 5 is a flowchart representation of a method 500 of providing audience feedback during performance of a presentation in accordance with some implementations. In various implementations, the method 500 is performed by a device including a display, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device displaying, on the display in association with an environment including a plurality of audience members, one or more slides of the presentation. In various implementations, the environment is an XR environment based on a physical environment including a plurality of physical audience members. In various implementations, the environment is a virtual environment including a plurality of virtual audience members (e.g., avatars of physical people). For example, in FIGS. 4A-4D, the electronic device displays the slide window 411 which displays, at various times, the first and second slides of the presentation. In various implementations, the device displays the one or more slides of the presentation in a slide window. In various implementations, the size and/or the location of the slide window is manipulable by a user of the device. For example, in various implementations, the user provides user input to move the slide window to a different location on the display. As another example, in various implementations, the user provides user input to change a size of the slide window. In various implementations, the slide window is at least partially transparent.

In various implementations, the display is an opaque display and the one or more slides of the presentation are displayed in association with the environment as a composite image of the one or more slides of the presentation and an image of the environment. Thus, in various implementations, displaying the one or more slides of the presentations includes displaying, based on the image of the environment, an image representation of the environment including the one or more slides of the presentation. In various implementations, the display is a transparent display and the one or more slides of the presentation are displayed in association with a physical environment as a projection over a view of the physical environment.

The method 500 continues, in block 520, with the device, while displaying the one or more slides of the presentation, obtaining data regarding the plurality of audience members. It is to be appreciated that the data regarding the plurality of audience members need not include data regarding each of the plurality of audience members. Rather, in various implementations, the data regarding the plurality of audience members includes data regarding one or more of the plurality of audience members.

In various implementations, obtaining the data regarding the plurality of audience members includes receiving data from one or more electronic devices of the plurality of audience members. For example, in FIG. 4A, the electronic device receives data from the member electronic devices 422A-422C regarding the plurality of audience members 421A-421C. In various implementations, the data from the one or more electronic devices is anonymized, e.g., not associated with a particular audience member of the plurality of audience members. In various implementations, before data is transmitted from an electronic device of an audience member, that audience member must affirmatively opt in to sharing the data with the electronic device (of the presenter). For example, in various implementations, before a presentation is begun, the electronic device transmits a request for data and for audience members to affirmatively respond to this request. Thus, in various implementations, the data from the one or more electronic devices is received in response to the plurality of audience members opting in to data sharing.

In various implementations, the data from the one or more electronic devices includes facial or eye tracking data of the plurality of audience members. For example, in FIG. 4B, the electronic device displays the eye tracking indicator 414 over the slide window 411 based on eye tracking data of the plurality of audience members received from the member electronic devices 422A-422C.

In various implementations, the data from the one or more electronic devices includes text input by the plurality of audience members. For example, in FIG. 4C, the electronic device displays the text feedback notification 415 including the text “POINT 2B?” based on text input by the plurality of audience members 421A-421C on the member electronic devices 422A-422C. In various implementations, the text input by the plurality of audience members includes text in a web browsing application (e.g., in a search bar), text in a notes application, or text in a messaging application.

In various implementations, obtaining the data regarding the plurality of audience members includes capturing one or more images of the plurality of audience members. For example, in FIG. 4A, the level of engagement indicated by the engagement bar 412A is, in various implementations, based on determining, from an image of the plurality of audience members, whether audience members are looking towards or away from the user or the facial expressions and/or body poses of audience members as either being consistent with being engaged with the presentation or not engaged with the presentation.

The method 500 continues, in block 530, with the device displaying, on the display in association with the environment, one or more virtual objects based on the data regarding the plurality of audience members. In various implementations, displaying the one or more virtual objects includes displaying an indication of a level of engagement of the plurality of audience members. In various implementations, displaying the one or more virtual objects includes displaying an indication of a level of understanding of the plurality of audience members. For example, in FIG. 4A, the electronic device displays the engagement bar 412A and the understanding bar 412B. In various implementations, the level of engagement and/or level of understanding are indicated using different virtual objects.

In various implementations, displaying the one or more virtual objects includes displaying a feedback notification. For example, in FIG. 4C, the electronic device displays the text feedback notification 415. In various implementations, the feedback notification is a display-locked object. In various implementations, the feedback notification is a world-locked object.

In various implementations, displaying the one or more virtual objects includes displaying a virtual object in association with a particular audience member of the plurality of audience members. For example, in FIG. 4A, the electronic device displays the member indicator 413 in association with the second audience member 421B. As another example, in FIG. 4D, the electronic device displays the virtual dim window 416 in association with the fourth audience member 421D.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-16. (canceled)

17. A method comprising:
at a device including a display, one or more processors, and non-transitory memory:
displaying, on the display in association with an environment including a plurality of audience members, one or more slides of a presentation;
while displaying the one or more slides of the presentation, obtaining data regarding the plurality of audience members; and
displaying, on the display in association with the environment, one or more virtual objects based on the data regarding the plurality of audience members.

18. The method of claim 17, wherein obtaining the data regarding the plurality of audience members includes receiving data from one or more electronic devices of the plurality of audience members.

19. The method of claim 18, wherein the data from the one or more electronic devices is anonymized.

20. The method of claim 18, wherein the data from the one or more electronic devices is received in response to the plurality of audience members opting in to data sharing.

21. The method of claim 18, wherein the data from the one or more electronic devices includes eye tracking data of the plurality of audience members.

22. The method of claim 18, wherein the data from the one or more electronic devices includes text input by the plurality of audience members.

23. The method of claim 17, wherein obtaining the data regarding the plurality of audience members includes capturing one or more images of the plurality of audience members.

24. The method of claim 17, wherein displaying the one or more virtual objects includes displaying an indication of a level of engagement of the plurality of audience members.

25. The method of claim 17, wherein displaying the one or more virtual objects includes displaying an indication of a level of understanding of the plurality of audience members.

26. The method of claim 17, wherein displaying the one or more virtual objects includes displaying a feedback notification.

27. The method of claim 17, wherein displaying the one or more virtual objects includes displaying a virtual object in association with a particular audience member of the plurality of audience members.

28. The method of claim 17, wherein displaying the one or more virtual objects includes displaying a heat map in association with the one or more slides indicative of gaze information of the plurality of audience members.

29. A device comprising:
a display,
a non-transitory memory; and
one or more processors to:
display, on the display in association with an environment including a plurality of audience members, one or more slides of a presentation;
while displaying the one or more slides of the presentation, obtain data regarding the plurality of audience members; and
display, on the display in association with the environment, one or more virtual objects based on the data regarding the plurality of audience members.

30. The device of claim 29, wherein the one or more processors are to obtain the data regarding the plurality of audience members by receiving data from one or more electronic devices of the plurality of audience members.

31. The device of claim 29, wherein the one or more processors are to obtain the data regarding the plurality of audience members by capturing one or more images of the plurality of audience members.

32. The device of claim 29, wherein the one or more processors are to display the one or more virtual objects by displaying an indication of a level of engagement of the plurality of audience members.

33. The device of claim 29, wherein the one or more processors are to display the one or more virtual objects by displaying an indication of a level of understanding of the plurality of audience members.

34. The device of claim 29, wherein the one or more processors are to display the one or more virtual objects by displaying a virtual object in association with a particular audience member of the plurality of audience members.

35. The device of claim 29, wherein the one or more processors are to display the one or more virtual objects by displaying a heat map in association with the one or more slides indicative of gaze information of the plurality of audience members.

36. A non-transitory memory storing one or more programs, which, when executed by one or more processors of a device including a display, cause the device to:
display, on the display in association with an environment including a plurality of audience members, one or more slides of a presentation;
while displaying the one or more slides of the presentation, obtain data regarding the plurality of audience members; and
display, on the display in association with the environment, one or more virtual objects based on the data regarding the plurality of audience members.
